(19) United States
(12) Patent Application Publication
(10) Pub. No.: US 2025/0330238 A1
(43) Pub. Date: Oct. 23, 2025

(54) COMMUNICATION APPARATUS, COMMUNICATION SYSTEM AND COMMUNICATION METHOD

(71) Applicant: NIPPON TELEGRAPH AND TELEPHONE CORPORATION, Tokyo (JP)

(72) Inventors: Yasunari TANAKA, Musashino-shi (JP); Takuya KANAI, Musashino-shi (JP); Kazutaka HARA, Tokyo (JP)

(73) Assignee: NIPPON TELEGRAPH AND TELEPHONE CORPORATION, Tokyo (JP)

(21) Appl. No.: 18/870,000

(22) PCT Filed: Jun. 2, 2022
(86) PCT No.: PCT/JP2022/022477

§ 371 Date: Nov. 27, 2024

(51) Int. Cl. H04B 10/077

(52) U.S. Cl. CPC H04B 10/077

(57) ABSTRACT

A communication device includes: a variable branching device that acquires, from a different communication device, an optical signal in accordance with a main signal with a control signal superimposed thereon at a superimposition ratio provided through a notification and branches the main signal into a first branched signal and a second branched signal in accordance with a designated branching ratio; an intensity measurement unit that measures optical power of the control signal in the second branched signal; and a control unit that selects a combination of the superimposition ratio and the branching ratio that minimizes a sum of main signal loss due to superimposition and branching from among combination candidates on the basis of minimum reception sensitivity of the optical power of the control signal and a result of measuring the optical power of the control signal, notifies the different communication device of the superimposition ratio in the selected combination, and designates the branching ratio in the selected combination for the variable branching device.

### TECHNICAL FIELD

The present invention relates to a communication device, a communication system, and a communication method.

### BACKGROUND ART

In the International Telecommunication Union Telecommunication Standardization sector (ITU-T) G.989.2 Recommendation, a point to point (PtP) wavelength division multiplexing (WDM)-passive optical network (PON) system is defined as one communication system (see Non Patent Literature 1).

A PtP WDM-PON system includes an optical line terminal (OLT) and an optical network unit (ONU). Hereinafter, the direction from the ONU to the OLT will be referred to as “uplink”. Hereinafter, the direction from the OLT to the ONU will be referred to as “downlink”.

The PtP WDM-PON system executes wavelength multiplexing of optical signals. In addition, the PtP WDM-PON system performs communication using optical signals of different wavelengths for each ONU in uplink and downlink.

In the PtP WDM-PON system, an auxiliary management and control channel (AMCC) signal is defined as a control signal including control information transmitted and received between the OLT and the ONU. The AMCC signal is superimposed on a main signal including transmission data modulated by a predetermined scheme. Since the AMCC signal is superimposed on the main signal, the wavelength range of the control signal falls within a wavelength range of the main signal. In this manner, the PtP WDM-PON system can manage and control the communication devices such as the OLT and the ONU without using a dedicated wavelength range for the control signal. In the PtP WDM-PON system, a wavelength determination process in which a wavelength of an optical signal in each of uplink and downlink directions is determined is executed by using the AMCC signal.

FIG. 11 is a diagram illustrating an example of a PtP WDM-PON system. In FIG. 11, the PtP WDM-PON system includes a plurality of “PtP WDM OLTs”, a wavelength multiplexing/demultiplexing unit, and a plurality of ONUs. An ONU includes a management control unit of the ONU, a transmission unit, a reception unit, and a multiplexing/demultiplexing unit. A PtP WDM OLT includes a management control unit of the OLT, a transmission unit, a reception unit, and a multiplexing/demultiplexing unit. The AMCC signal is superimposed on the main signal in a stage of an optical signal. Also, the AMCC signal is separated from the main signal in a stage of an electrical signal.

FIG. 12 is a diagram illustrating an example of optical power of an optical signal with a control signal (AMCC signal) superimposed thereon. The AMCC signal is transmitted from, for example, an ONU or an OLT. A control signal is superimposed on an optical signal to be transmitted, and intensity modulation is executed on an envelope of optical power of a main signal with the control signal superimposed thereon. The data speed of the main signal is high (Gb/s). On the other hand, the data speed of the control signal is low (kb/s) (see Non Patent Literature 2).

### CITATION LIST

### Non Patent Literature

Non Patent Literature 1: ITU-T G.989.2 Recommendation, “40-Gigabit-capable-passive optical networks (NG-PON2): Physical media dependent (PMD) layer specification,” Feb. 2019.
Non Patent Literature 2: Y. Luo, H. Roberts, K. Grobe, M. Valvo, D. Nesset, K. Asaka, H. Rohde, J. Smith, J. S. Wey, and F. Effenberger, “Physical Layer Aspects of NG-PON2 Standards-Part 2: System Design and Technology Feasibility,” J. Opt. Commun. Netw., 8(1), pp. 43-52, January 2016.

### SUMMARY OF INVENTION

### Technical Problem

As described above, the data speed of the AMCC signal is lower than the data speed of the main signal. In a communication system such as a PtP WDM-PON system, such an AMCC signal is superimposed on a main signal, and it is thus possible to transmit and receive control information without depending on a protocol.

FIG. 13 is a diagram illustrating a first example of a configuration of a communication system. In FIG. 13, a communication device (a master station and a slave station) that receives a main signal transmitted using an optical signal acquires an AMCC signal superimposed on the main signal. FIG. 14 is a diagram illustrating a second example of a configuration of a communication system. In FIG. 14, a communication device (a master station that manages a network) that is different from a communication device (slave station) that receives a main signal transmitted using an optical signal acquires an AMCC signal superimposed on the main signal.

The communication system includes a branching device in the middle of a path of the optical signal. A communication device (a master station and a slave station) that acquires an AMCC signal includes an AMCC signal acquisition unit. The branching device causes a transmission/reception unit and the AMCC signal acquisition unit to branch the optical signal in the middle of the path of the optical signal. The AMCC signal acquisition unit acquires one of the branched AMCC signals.

However, since the optical power of the main signal is attenuated by the optical signal being branched, the transmission distance of the main signal is shortened. In addition, since the AMCC signal superimposed on the main signal becomes noise for the main signal, signal quality of the main signal deteriorates and the transmission distance of the main signal is shortened as the superimposition ratio of the optical power of the AMCC signal to the optical power of the main signal increases. As described above, there is a problem that it is not possible to maximize the amount of light (power budget) that can be used for the main signal with the control signal superimposed thereon while enabling reception of the control signal.

In view of the above circumstances, an object of the present invention is to provide a communication device, a communication system, and a communication method capable of maximizing the amount of light that can be used for a main signal with a control signal superimposed thereon while enabling reception of the control signal.

### Solution to Problem

An aspect of the present invention is a communication device including: a variable branching device that acquires, from a different communication device, an optical signal in accordance with a main signal with a control signal superimposed thereon at a superimposition ratio provided through a notification and branches the main signal into a first branched signal and a second branched signal in accordance with a designated branching ratio; an intensity measurement unit that measures optical power of the control signal in the second branched signal; and a control unit that selects a combination of the superimposition ratio and the branching ratio that minimizes a sum of main signal loss due to superimposition and branching from among combination candidates on the basis of minimum reception sensitivity of the optical power of the control signal and a result of measuring the optical power of the control signal, notifies the different communication device of the superimposition ratio in the selected combination, and designates the branching ratio in the selected combination for the variable branching device.

An aspect of the present invention is a communication system including: a first communication device; and a second communication device, in which the first communication device includes a transmission unit that superimposes a control signal on a main signal at a superimposition ratio provided through a notification and transmits an optical signal in accordance with the main signal with the control signal superimposed thereon, and the second communication device includes a variable branching device that acquires the optical signal from the transmission unit and branches the main signal into a first branched signal and a second branched signal in accordance with a designated branching ratio, an intensity measurement unit that measures optical power of the control signal in the second branched signal, and a control unit that selects a combination of the superimposition ratio and the branching ratio that minimizes a sum of main signal loss due to superimposition and branching from among combination candidates on the basis of minimum reception sensitivity of the optical power of the control signal and a result of measuring the optical power of the control signal, notifies the first communication device of the superimposition ratio in the selected combination, and designates the branching ratio in the selected combination for the variable branching device.

An aspect of the present invention is a communication method that is executed by a communication device, the method including the steps of: acquiring, from a different communication device, an optical signal in accordance with a main signal with a control signal superimposed thereon at a superimposition ratio provided through a notification and branching the main signal into a first branched signal and a second branched signal in accordance with a designated branching ratio; measuring optical power of the control signal in the second branched signal; and selecting a combination of the superimposition ratio and the branching ratio that minimizes a sum of main signal loss due to superimposition and branching from among combination candidates on the basis of minimum reception sensitivity of the optical power of the control signal and a result of measuring the optical power of the control signal, notifying the different communication device of the superimposition ratio in the selected combination, and designating the branching ratio in the selected combination for a variable branching device that branches the main signal into a first branched signal and a second branched signal.

### Advantageous Effects of Invention

According to the present invention, it is possible to maximize the amount of light that can be used for a main signal with a control signal superimposed thereon while enabling reception of the control signal.

### BRIEF DESCRIPTION OF DRAWINGS

FIG. 1 is a diagram illustrating a configuration example of a communication system in a first embodiment.

FIG. 2 is a diagram illustrating a configuration example of a variable branching device in the first embodiment.

FIG. 3 is a diagram illustrating an example of a data table at “a branching ratio=1.0” in the first embodiment.

FIG. 4 is a diagram illustrating an example of a data table at “a branching ratio=0.9” in the first embodiment.

FIG. 5 is a diagram illustrating an example of a data table at “a branching ratio=0.8” in the first embodiment.

FIG. 6 is a flowchart illustrating an operation example of the communication system in the first embodiment.

FIG. 7 is a diagram illustrating a configuration example of a communication system in a modification example of the first embodiment.

FIG. 8 is a diagram illustrating an example of a data table at “a branching ratio=1.0” in the modification example of the first embodiment.

FIG. 9 is a view illustrating a configuration example of a communication system in a second embodiment.

FIG. 10 is a diagram illustrating a hardware configuration example of a communication device in each embodiment.

FIG. 11 is a diagram illustrating an example of a PtP WDM-PON system.

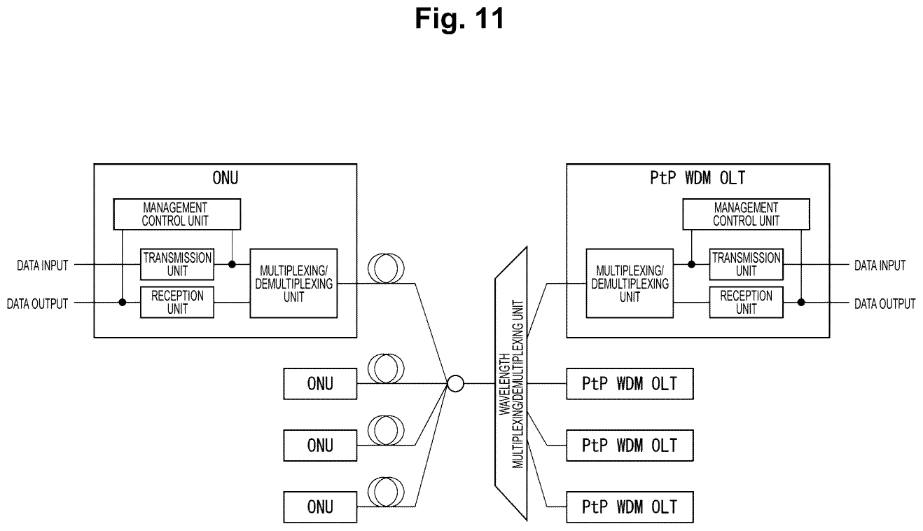

FIG. 12 is a diagram illustrating an example of optical power of an optical signal with a control signal superimposed thereon.

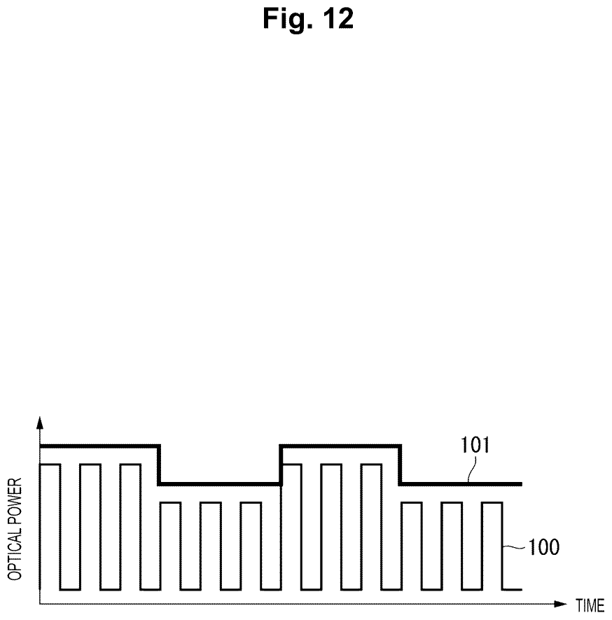

FIG. 13 is a diagram illustrating a first example of a configuration of a communication system.

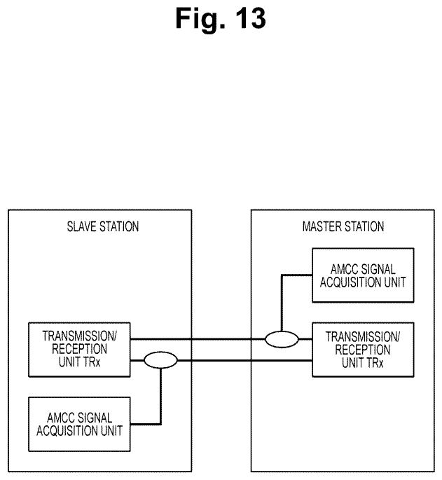

FIG. 14 is a diagram illustrating a second example of a configuration of a communication system.

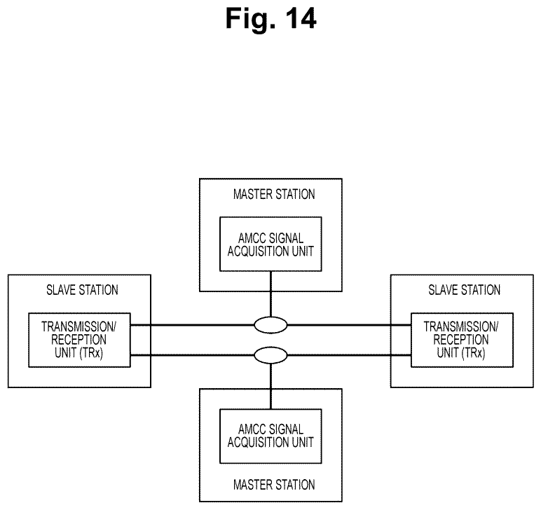

### DESCRIPTION OF EMBODIMENTS

Embodiments of the present invention will be described in detail with reference to the drawings.

### First Embodiment

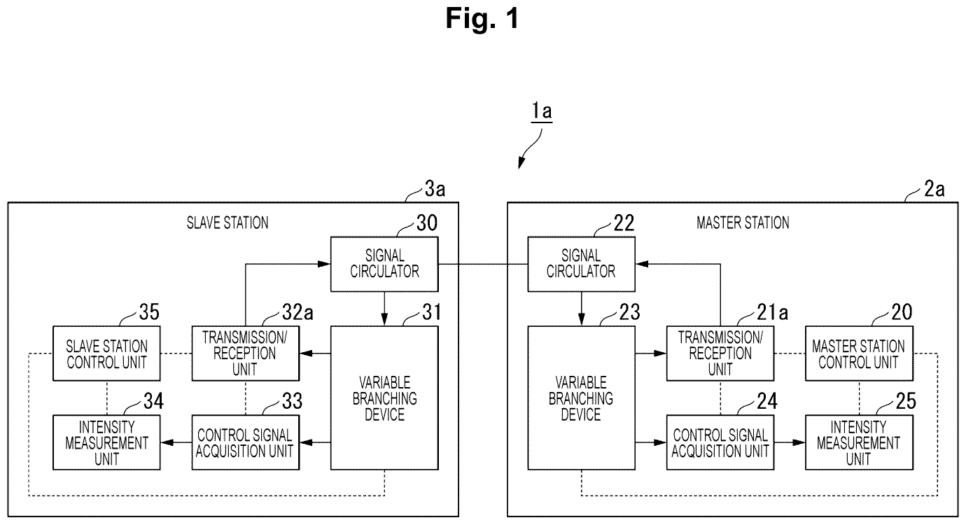

FIG. 1 is a diagram illustrating a configuration example of a communication system 1a in a first embodiment. The communication system 1a is a system (optical communication system) that performs communication using optical signals. The optical signals are used for transmission of a main signal and a control signal. The control signal is, for example, an AMCC signal. The data speed of the control signal is lower than the data speed of the main signal. The control signal is superimposed on the main signal at a predetermined superimposition ratio in a stage of an optical signal to be transmitted. The superimposition ratio is, for example, a ratio (proportion) of optical power of the control signal to optical power of the optical signal. Also, the control signal is separated from an electrical signal including the main signal and the control signal in a stage of an electrical signal obtained through conversion from a received optical signal.

The communication system 1a includes a master station 2a and a slave station 3a. The master station 2a faces the slave station 3a. The master station 2a is, for example, an optical line terminal (OLT). The slave station 3a is, for example, an optical network unit (ONU). The communication system 1a may include another slave station (not illustrated) facing the slave station 3a.

The master station 2a includes a master station control unit 20, a transmission/reception unit 21a, a signal circulator 22, a variable branching device 23, a control signal acquisition unit 24, and an intensity measurement unit 25.

The slave station 3a includes a signal circulator 30, a variable branching device 31, a transmission/reception unit 32a, a control signal acquisition unit 33, an intensity measurement unit 34, and a slave station control unit 35.

Hereinafter, a value in which “the optical power of the optical signal branched into the transmission/reception unit” is defined as a numerator, and the sum of “the optical power of the optical signal branched into the transmission/reception unit” and “the optical power of the optical signal branched into the control signal acquisition unit” is defined as a denominator will be referred to as a “branching ratio”. In a case where “the optical power of the optical signal branched into the transmission/reception unit:the optical power of the optical signal branched into the control signal acquisition unit” is “10:0”, for example, the branching ratio will be described as “1.0” or “10:0”. In a case where “the optical power of the optical signal branched into the transmission/reception unit:the optical power of the optical signal branched into the control signal acquisition unit” is “9:1”, for example, the branching ratio will be described as “0.9” or “9:1”. In a case where “the optical power of the optical signal branched into the transmission/reception unit:the optical power of the optical signal branched into the control signal acquisition unit” is “0:10”, for example, the branching ratio will be described as “0.0” or “0:10”.

First, the master station 2a will be described.

The master station control unit 20 (control unit) includes a data table. The master station control unit 20 controls operations of each functional unit of the master station 2a. The master station control unit 20 sets the branching ratio of an uplink-transmitted optical signal in the variable branching device 23 to “0.0” in a stage of initial setting before operating of the master station 2a is started. In this manner, almost all the optical power of the optical signal uplink-received by the signal circulator 22 is input to the control signal acquisition unit 24 via the variable branching device 23. Here, the master station control unit 20 acquires a result of measuring the optical power of the control signal by the control signal acquisition unit 24 from the intensity measurement unit 25. Since almost all the optical power of the optical signal uplink-received by the signal circulator 22 has been input to the control signal acquisition unit 24, this measurement result represents an upper limit (threshold value) of the optical power of the control signal.

The master station control unit 20 stores in advance a data table for each branching ratio in regard to the optical power and loss of the optical signal. Details of the data table for each branching ratio will be described later. The master station control unit 20 selects, for the uplink-transmitted optical signal, a combination of a branching ratio and a superimposition ratio that minimizes a sum of main signal loss caused by superimposition and branching, by using the data table for each branching ratio on the basis of the optical power of the optical signal at the control signal acquisition unit 24.

The master station control unit 20 notifies the slave station control unit 35 of a request signal for the superimposition ratio of the control signal in the optical signal to be uplink-transmitted, on the basis of the selected combination. Furthermore, the master station control unit 20 controls operations of the variable branching device 23 such that the variable branching device 23 branches the optical signal at the branching ratio in the selected combination.

The master station control unit 20 acquires, from the slave station control unit 35, the request signal for the superimposition ratio of the control signal in the optical signal to be downlink-transmitted. For example, the master station control unit 20 acquires, from the slave station control unit 35, the request signal for the superimposition ratio of the control signal in the optical signal to be downlink-transmitted in the stage of initial setting before operating of the master station 2a is started. The master station control unit 20 controls the superimposition ratio of the control signal in the optical signal to be downlink-transmitted from the transmission/reception unit 21a on the basis of the request signal for the superimposition ratio acquired from the slave station control unit 35.

The master station control unit 20 acquires, from the transmission/reception unit 21a, a main signal uplink-transmitted from the slave station 3a in an operating stage of the master station 2a (a stage after the initial setting is done). The master station control unit 20 acquires, from the control signal acquisition unit 24, the control signal uplink-transmitted from the slave station 3a. Here, the master station control unit 20 may acquire the control signal from the control signal acquisition unit 24 via the transmission/reception unit 21a. Note that even in the stage of the initial setting before operating of the master station 2a is started, the master station control unit 20 may acquire the main signal uplink-transmitted from the slave station 3a.

The transmission/reception unit 21a (TRₓ) (transmission unit of the master station) (reception unit of the master station) acquires, from the variable branching device 23, the optical signal branched into the transmission/reception unit 21a. The transmission/reception unit 21a converts the acquired optical signal into an electrical signal. The transmission/reception unit 21a outputs a main signal (electric signal) to the master station control unit 20.

The transmission/reception unit 21a superimposes the control signal on the main signal of the optical signal to be downlink-transmitted in accordance with control performed by the master station control unit 20. In other words, the transmission/reception unit 21a superimposes the control signal on the main signal of the optical signal to be downlink-transmitted at the superimposition ratio requested by the slave station control unit 35. The transmission/reception unit 21a outputs an optical signal in accordance with the main signal with the control signal superimposed thereon to the signal circulator 22.

The signal circulator 22 is, for example, a circulator or an upper/lower separation filter. The signal circulator 22 outputs the optical signal uplink-transmitted from the slave station 3a to the variable branching device 23. The signal circulator 22 downlink-transmits the optical signal downlink-transmitted from the transmission/reception unit 21a to the slave station 3a.

The variable branching device 23 branches the optical signal input from the signal circulator 22 into the transmission/reception unit 21a and the control signal acquisition unit 24 at a variable branching ratio in accordance with the control performed by the master station control unit 20. The variable branching device 23 is, for example, an evanescent coupling-type optical coupler or a planar lightwave circuit (PLC).

The control signal acquisition unit 24 acquires the optical signal branched into the control signal acquisition unit 24 from the variable branching device 23. In the control signal acquisition unit 24, the minimum reception sensitivity of the optical power of the control signal is determined in advance. The control signal acquisition unit 24 converts the optical signal acquired from the variable branching device 23 into an electrical signal. The control signal acquisition unit 24 outputs the uplink-transmitted control signal (electrical signal) to the master station control unit 20. The control signal acquisition unit 24 may output the control signal to the master station control unit 20 via the transmission/reception unit 21a.

The intensity measurement unit 25 measures the optical power of the control signal at the control signal acquisition unit 24. The intensity measurement unit 25 outputs a result of measuring the optical power of the control signal to the master station control unit 20.

Next, the slave station 3a will be described.

The signal circulator 30 is, for example, a circulator or an upper/lower separation filter. The signal circulator 30 outputs the optical signal downlink-transmitted from the master station 2a to the variable branching device 31. The signal circulator 30 outputs the optical signal uplink-transmitted from the transmission/reception unit 32a to the master station 2a.

The variable branching device 31 branches the optical signal input from the signal circulator 30 into the transmission/reception unit 32a and the control signal acquisition unit 33 at a variable branching ratio in accordance with the control performed by the slave station control unit 35. In other words, the variable branching device 31 outputs, to the transmission/reception unit 32a, a first branched signal of the optical signal input from the signal circulator 30 at the variable branching ratio in accordance with the control performed by the slave station control unit 35. The variable branching device 31 outputs, to the control signal acquisition unit 33, a second branched signal of the optical signal input from the signal circulator 30 at the variable branching ratio in accordance with the control performed by the slave station control unit 35. The variable branching device 31 is, for example, an evanescent coupling-type optical coupler or a planar optical circuit.

The transmission/reception unit 32a (TRₓ) (the transmission unit of the slave station) (the reception unit of the slave station) acquires, from the variable branching device 31, the optical signal branched into the transmission/reception unit 32a. The transmission/reception unit 32a converts the acquired optical signal into an electrical signal. The transmission/reception unit 32a outputs a main signal (electric signal) to the slave station control unit 35.

The transmission/reception unit 32a superimposes the control signal on the main signal of the optical signal to be uplink-transmitted in accordance with control performed by the slave station control unit 35. In other words, the transmission/reception unit 32a superimposes the control signal on the main signal of the optical signal to be uplink-transmitted at the superimposition ratio requested by the master station control unit 20. The transmission/reception unit 32a outputs an optical signal in accordance with the main signal with the control signal superimposed thereon to the signal circulator 30.

The control signal acquisition unit 33 acquires the optical signal branched into the control signal acquisition unit 33 from the variable branching device 23. The control signal acquisition unit 33 converts the optical signal acquired from the variable branching device 31 into an electrical signal. The control signal acquisition unit 33 outputs the downlink-transmitted control signal (electrical signal) to the slave station control unit 35. The control signal acquisition unit 33 may output the control signal to the slave station control unit 35 via the transmission/reception unit 32a.

The intensity measurement unit 34 measures the optical power of the control signal at the control signal acquisition unit 33. The intensity measurement unit 34 outputs a result of measuring the optical power of the control signal to the slave station control unit 35.

The slave station control unit 35 (control unit) includes a data table. The slave station control unit 35 controls operations of each functional unit of the slave station 3a. The slave station control unit 35 sets the branching ratio of a downlink-transmitted optical signal at the variable branching device 31 to “0.0” in the stage of initial setting before operating of the slave station 3a is started, for example. In this manner, almost all the optical power of the optical signal downlink-received by the signal circulator 30 is input to the control signal acquisition unit 33 via the variable branching device 31. Here, the slave station control unit 35 acquires a result of measuring the optical power of the control signal by the control signal acquisition unit 33 from the intensity measurement unit 34. Since almost all the optical power of the optical signal downlink-received by the signal circulator 30 has been input to the control signal acquisition unit 33, this measurement result represents an upper limit (threshold value) of the optical power of the control signal.

The slave station control unit 35 stores in advance a data table for each branching ratio in regard to the optical power and loss of the optical signal. Details of the data table for each branching ratio will be described later. The slave station control unit 35 selects, for the downlink-transmitted optical signal, a combination of a branching ratio and a superimposition ratio that minimizes a sum of main signal loss caused by superimposition and branching, by using the data table for each branching ratio on the basis of the optical power of the optical signal at the control signal acquisition unit 33.

The slave station control unit 35 notifies the master station control unit 20 of a request signal for the superimposition ratio of the control signal in the optical signal to be downlink-transmitted, on the basis of the selected combination. Furthermore, the slave station control unit 35 controls operations of the variable branching device 31 such that the variable branching device 31 branches the optical signal at the branching ratio in the selected combination.

The slave station control unit 35 acquires, from the master station control unit 20, the request signal for the superimposition ratio of the control signal in the optical signal to be uplink-transmitted. For example, the slave station control unit 35 acquires, from the master station control unit 20, the request signal for the superimposition ratio of the control signal in the optical signal to be uplink-transmitted in the stage of initial setting before operating of the slave station 3a is started. The slave station control unit 35 controls the superimposition ratio of the control signal in the optical signal to be uplink-transmitted from the transmission/reception unit 32a on the basis of the request signal for the superimposition ratio acquired from the master station control unit 20.

The slave station control unit 35 acquires, from the transmission/reception unit 32a, a main signal downlink-transmitted from the master station 2a in an operating stage of the slave station 3a (a stage after the initial setting is done). The slave station control unit 35 acquires, from the control signal acquisition unit 33, the control signal downlink-transmitted from the master station 2a. Here, the slave station control unit 35 may acquire the control signal from the control signal acquisition unit 33 via the transmission/reception unit 32a. Note that the slave station control unit 35 may acquire the main signal downlink-transmitted from the master station 2a in the stage of initial setting before operating of the slave station 3a is started.

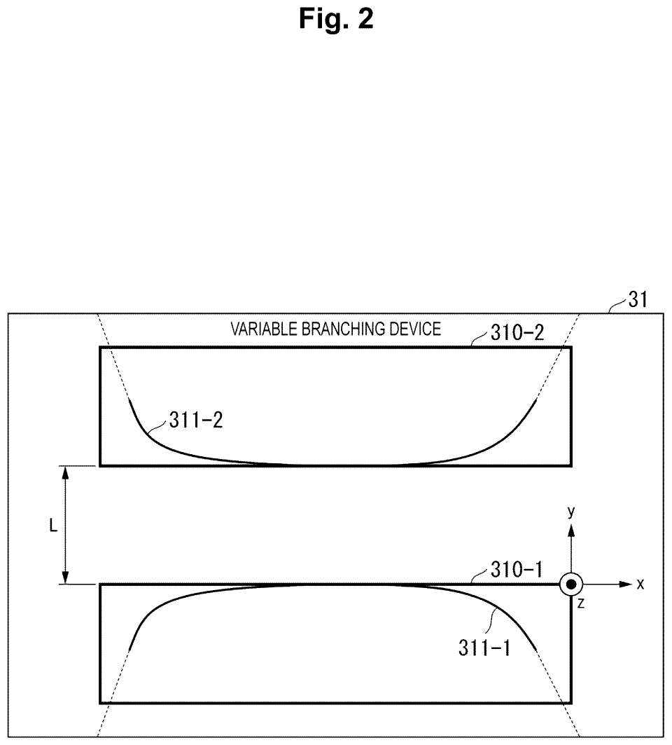

FIG. 2 is a diagram illustrating a configuration example of variable branching device 31 in the first embodiment. The configuration of the variable branching device 31 is not limited to a specific configuration as long as the optical signal can be branched at a variable branching ratio. Note that the configuration of the variable branching device 23 may be similar to the configuration of the variable branching device 31.

In FIG. 2, the variable branching device 31 includes a base 310-1 and a base 310-2 in an example. The table 310-1 includes an optical fiber 311-1 as a path of an optical signal branched into the transmission/reception unit 32a. The base 310-2 includes an optical fiber 311-2 as a path of an optical signal branched into the control signal acquisition unit 33.

The optical fiber 311-1 comes into contact with the optical fiber 311-2 by the distance “L” between a core of the optical fiber 311-1 and a core of the optical fiber 311-2 becoming equal to or less than a predetermined distance. For example, a part of an optical signal propagated through the optical fiber 311-1 is branched into the optical fiber 311-2 at a branching ratio in accordance with the length of the contact part of the optical fibers 311.

The variable branching device 31 adjusts the branching ratio of the optical signal in the optical fiber 311-1 by changing the distance “L” between the core of the optical fiber 311-1 and the core of the optical fiber 311-2 in accordance with the control performed by the slave station control unit 35. The slave station control unit 35 causes the base 310-2 to approach the base 310-1 such that the distance “L” between the cores becomes a predetermined distance (a distance corresponding to the derived branching ratio). The slave station control unit 35 may cause the base 310-2 to move in a y-axis direction or may cause the base 310-2 to move in a z-axis direction.

Next, the data table for each branching ratio will be described.

Each measurement value in the data table is measured in advance. Note that the branching ratio is arbitrary and is not necessarily limited to the “branching ratio =1.0”, “branching ratio =0.9”, and “branching ratio =0.8” exemplified below. Similarly, the superimposition ratio is also arbitrary. Additionally, each of units of loss, sensitivity, and optical power is arbitrary. Each of units of loss, sensitivity, and optical power may be described as logarithms and may be, for example, “dB” or “dBm”.

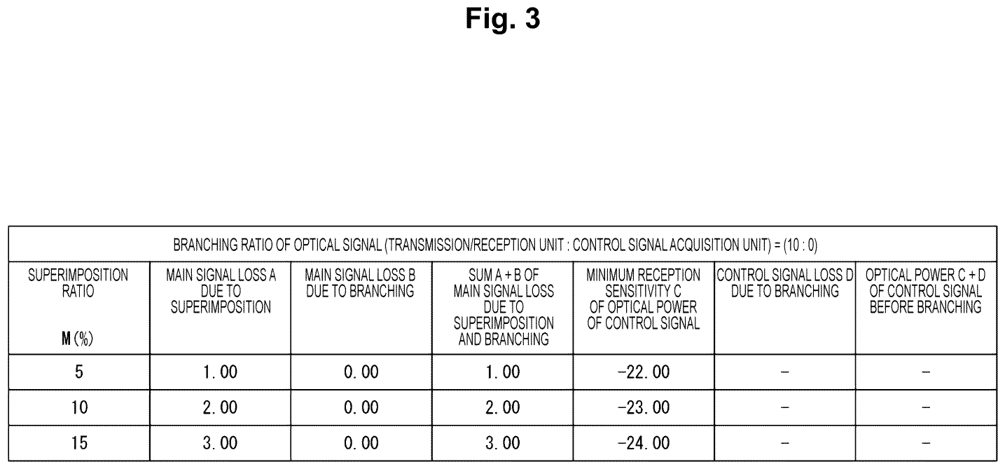

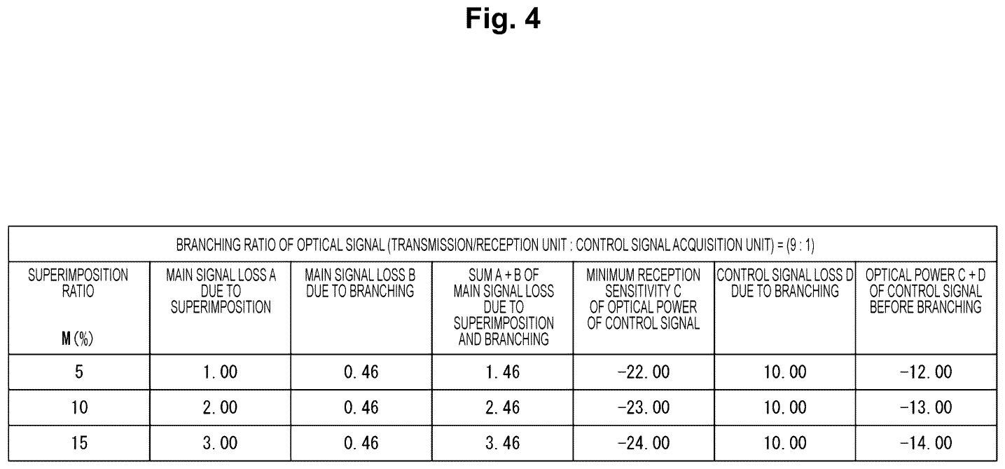

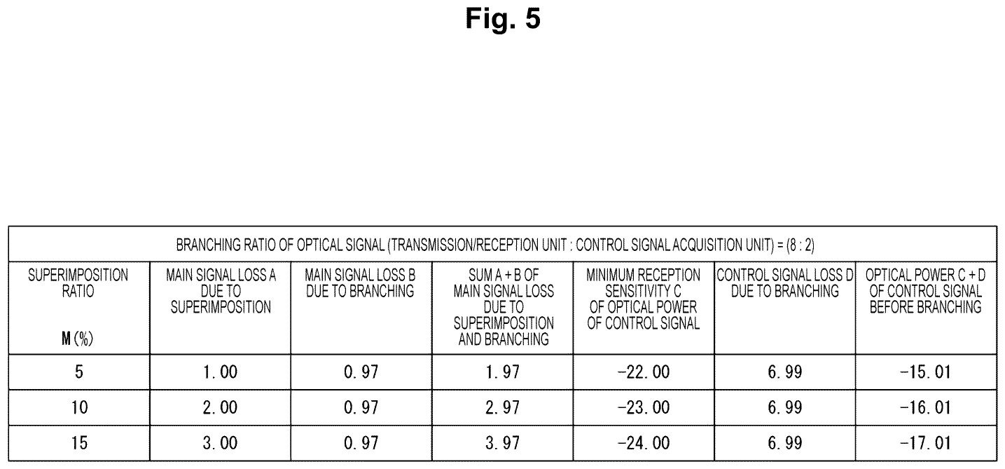

FIG. 3 is a diagram illustrating an example of a data table at the “branching ratio=1.0” in the first embodiment. FIG. 4 is a diagram illustrating an example of a data table at the “branching ratio=0.9” in the first embodiment. FIG. 5 is a diagram illustrating an example of a data table at the “branching ratio=0.8” in the first embodiment.

In the data table for each branching ratio, a superimposition ratio, main signal loss due to superimposition (penalty that quality of the main signal takes), a sum of main signal loss due to superimposition and branching, minimum reception sensitivity of the optical power of the control signal, control signal loss due to branching, and optical power of the control signal before branching are associated in advance.

Next, a method of selecting a combination of a superimposition ratio and a branching ratio will be described. Here, since the selection methods are similar for the uplink and the downlink, a method of selecting a combination of a superimposition ratio and a branching ratio of an optical signal for the downlink will be described as an example.

The slave station control unit 35 sets the branching ratio of the optical signal at the variable branching device 31 to “0.0”. In this manner, almost all the optical power of the optical signal downlink-received by the signal circulator 30 is input to the control signal acquisition unit 33 via the variable branching device 31. Here, the intensity measurement unit 34 measures the optical power of the control signal at the control signal acquisition unit 33. Since almost all the optical power of the optical signal downlink-received by the signal circulator 30 has been input to the control signal acquisition unit 33, this measurement result represents an upper limit (threshold value) of the optical power of the control signal. Hereinafter, the upper limit of the optical power of the control signal is “−13.00” as an example.

Therefore, the slave station control unit 35 selects a row (range) in which the optical power of the control signal before the branching is less than “−13.00” from the data table for each branching ratio. In regard to the data table illustrated as an example in FIG. 4, for example, the slave station control unit 35 selects the row in which “the optical power of the optical signal received by the transmission/reception unit” is “−14.00” is selected as a combination candidate. In regard to the data table illustrated as an example in FIG. 5, for example, the slave station control unit 35 selects each of the rows in which “the optical power of the optical signal received by the transmission/reception unit” is “−15.01”, “−16.01”, and “−17.01” as each combination candidate.

The slave station control unit 35 selects, from the candidates, a combination of a branching ratio and a superimposition ratio according to which the optical power of the control signal received by the control signal acquisition unit 33 (the control signal in the second branched signal) is equal to or greater than the minimum reception sensitivity “C” and a sum “A+B” of main signal loss due to superimposition and branching is minimum. The slave station control unit 35 selects, from the candidates, a combination of a branching ratio and a superimposition ratio according to which the condition that the sum of control signal loss “D” due to branching and the minimum reception sensitivity “C” is the optical power “C+D” of the control signal before the branching is satisfied and further, the sum “A+B” of the main signal loss due to superimposition and branching is minimum.

In the data tables illustrated as examples in FIGS. 3, 4, and 5, for example, the slave station control unit 35 selects a combination of a superimposition ratio of “5%” and a branching ratio of “0.8” such that the sum of the main signal loss due to superimposition and branching becomes the minimum value “1.97”. In other words, the slave station control unit 35 selects the superimposition ratio “M=5%” in the data table for the branching ratio of “0.8”.

The slave station control unit 35 outputs a request signal representing the superimposition ratio of “M=5%” to the transmission/reception unit 32a. The transmission/reception unit 32a transmits a request signal representing the superimposition ratio to the master station 2a. The slave station control unit 35 sets the branching ratio of the optical signal downlink-transmitted at the variable branching device 31 to “0.8”. The variable branching device 31 branches the optical signal input from the signal circulator 30 into the optical signals to the transmission/reception unit 32a and the control signal acquisition unit 33 at the variable branching ratio “0.8” in accordance with control performed by the slave station control unit 35. In this manner, it is possible to maximize the amount of light (power budget) that can be used for the main signal with the control signal superimposed thereon while enabling reception of the downlink-transmitted control signal.

Next, an operation example of the communication system 1a will be described.

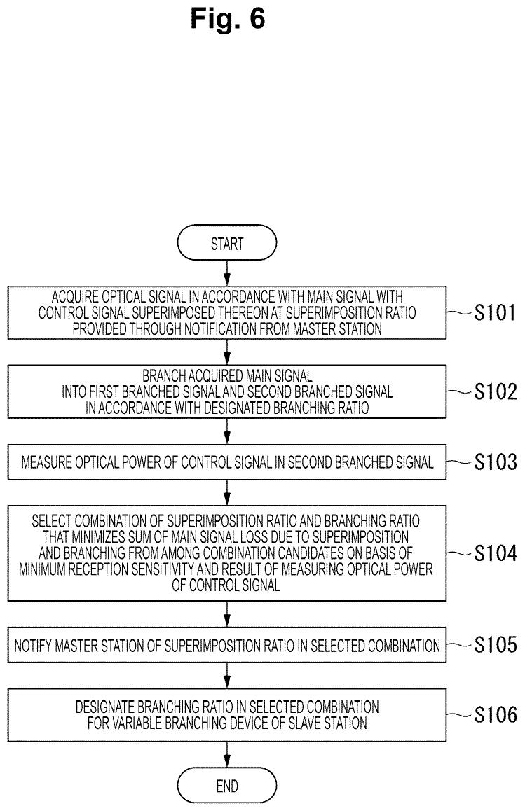

FIG. 6 is a flowchart illustrating an operation example of a communication system 1a in the first embodiment. The variable branching device 31 acquires an optical signal in accordance with the main signal with the control signal superimposed thereon at the superimposition ratio provided through a notification to the master station control unit 20, from the transmission/reception unit 21a via the signal circulator 22 and the signal circulator 30 (step S101).

The variable branching device 31 branches the main signal into a first branched signal and a second branched signal in accordance with the branching ratio designated by the slave station control unit 35 (step S102). The intensity measurement unit 34 measures optical power of the control signal in the second branched signal input to the control signal acquisition unit 33 (step S103).

The slave station control unit 35 selects a combination of a superimposition ratio and a branching ratio that minimizes a sum of main signal loss due to superimposition and branching from combination candidates on the basis of minimum reception sensitivity of the optical power of the control signal and the result of measuring the optical power of the control signal (step S104). The slave station control unit 35 notifies the master station control unit 20 of the superimposition ratio in the selected combination (step S105). The slave station control unit 35 designates the branching ratio in the selected combination for the variable branching device 31 (step S106).

Note that the transmission direction of the control signal is not limited to one of uplink and downlink directions. In other words, the control signal may be transmitted from the master station to the slave station or may be transmitted from the slave station to the master station. Such a fact that the control signal can be transmitted in both directions is a common matter for each embodiment and modification examples thereof. The flowchart illustrated as an example in FIG. 6, for example, can be executed through similar steps even if the words “master station” and “slave station” are switched.

Since the control signal can be transmitted in both directions, the master station 2a may be described as a “first communication device” or a “different communication device”, while the slave station 3a may be described as a “second communication device” or a “host communication device”. The master station 2a may be described as a “second communication device” or a “host communication device”, while the slave station 3a may be described as a “first communication device” or a “different communication device”.

As described above, the master station 2a superimposes the control signal on the main signal at the superimposition ratio provided through a notification from the slave station 3a. The variable branching device 31 acquires, from the master station 2a, an optical signal in accordance with the main signal with the control signal superimposed thereon. The variable branching device 31 branches the main signal into a first branched signal and a second branched signal in accordance with the designated branching ratio. The intensity measurement unit 34 measures the optical power of the control signal in the second branched signal. The slave station control unit 35 selects a combination of a superimposition ratio and a branching ratio that minimizes a sum of main signal loss due to superimposition and branching from combination candidates (data table) on the basis of minimum reception sensitivity of the optical power of the control signal and the result of measuring the optical power of the control signal. The slave station control unit 35 notifies the master station control unit 20 of the superimposition ratio in the selected combination. The slave station control unit 35 designates the branching ratio in the selected combination for the variable branching device 31.

In this manner, the control signal at a low data speed is superimposed on the main signal at a high data speed, and the main signal and the control signal are delivered by using the optical signal. In such a communication system, the superimposition ratio of the main signal and the control signal in the optical signal and the branching ratio of the splitter that branches a part of the optical signal in the course of the path are variable in accordance with the transmission distance of the control signal at the low data speed. The communication system 1a executes communication on the basis of the combination of the superimposition ratio and the branching ratio that minimizes a total value of a penalty of the main signal and branching loss due to superimposition of the control signal within a range in which the control signal at the low data speed can be received.

In this manner, it is possible to maximize the amount of light (power budget) that can be used for the main signal with the control signal superimposed thereon while enabling reception of the control signal. Also, it is possible to improve the transmission distance of the optical signal. It is possible to maximize the budget in accordance with the wavelength by the loss for each wavelength of the optical signal in an optical component being taken into consideration.

It is possible to perform communication setting regardless of the type of the main signal by a facing communication device performing communication using an AMCC signal at the time of initial connection. In a case where the type of the main signal in the facing communication device is unified, the facing communication device may perform communication using the main signal.

In the above description, the slave station control unit 35 sets the branching ratio of the optical signal downlink-transmitted at the variable branching device 31 to “0.0” in the stage of initial setting before operating of the slave station 3a is started, for example. The reason that the branching ratio is set to “0.0” is for simplifying the description. The intensity measurement unit 34 may measure the optical power of the control signal at the control signal acquisition unit 33 after the slave station control unit 35 acquires information regarding the branching ratio of the optical signal downlink-transmitted at the variable branching device 31.

Instead of the intensity measurement unit 25 measuring the optical power of the control signal uplink-received at the control signal acquisition unit 24, the master station control unit 20 may acquire, from the slave station control unit 35, the optical signal uplink-transmitted from the transmission/reception unit 32a or information regarding the optical power of the control signal by using the transmission/reception unit 21a. The master station control unit 20 holds in advance information representing loss of optical power caused by each optical component in the transmission path in the communication system 1a. The master station control unit 20 transmits information representing the distance between a predetermined position and the master station 2a (hereinafter, referred to as a “master station inter-user distance”) to the slave station control unit 35 by using the control signal. The master station control unit 20 acquires the control signal representing the distance between the predetermined position and the slave station 3a (hereinafter, referred to as a slave station inter-user distance”) from the slave station control unit 35. The master station control unit 20 derives the transmission distance of the optical signal between the slave station 3a and the master station 2a on the basis of the predetermined position, the master station inter-user distance, and the slave station inter-user distance. The master station control unit 20 derives loss of the optical power of the optical signal or the control signal in the transmission path in the communication system la on the basis of the transmission distance of the optical signal between the slave station 3a and the master station 2a. The master station control unit 20 may derive the optical power of the control signal uplink-received at the control signal acquisition unit 24 on the basis of the loss of the optical power of the optical signal or the control signal in the transmission path in the communication system 1a and information regarding the optical power of the optical signal or the control signal uplink-transmitted from the transmission/reception unit 32a.

Instead of the intensity measurement unit 34 measuring the optical power of the control signal downlink-received at the control signal acquisition unit 33, the slave station control unit 35 may acquire the information regarding the optical power of the optical signal or the control signal downlink-transmitted from the transmission/reception unit 21a from the master station control unit 20 by using the transmission/reception unit 32a. The slave station control unit 35 holds in advance information representing loss of optical power caused by each optical component in the transmission path in the communication system 1a. The slave station control unit 35 transmits information representing the slave station inter-user distance to the master station control unit 20 by using the control signal. The slave station control unit 35 acquires the control signal representing the master station inter-user distance from the master station control unit 20. The slave station control unit 35 derives the transmission distance of the optical signal between the slave station 3a and the master station 2a on the basis of the predetermined position, the master station inter-user distance, and the slave station inter-user distance. The slave station control unit 35 derives loss of the optical power of the optical signal or the control signal in the transmission path in the communication system 1aon the basis of the transmission distance of the optical signal between the slave station 3a and the master station 2a. The slave station control unit 35 may derive the optical power of the control signal downlink-received at the control signal acquisition unit 33 on the basis of the loss of the optical power of the optical signal or the control signal in the transmission path in the communication system 1a and information regarding the optical power of the optical signal or the control signal downlink-transmitted from the transmission/reception unit 21a.

### Modification Example of First Embodiment

A modification example of the first embodiment is different from the first embodiment mainly in that the transmission/reception unit acquires a control signal rather than a main signal. In other words, a main difference from the first embodiment is that the transmission/reception unit includes a control signal acquisition unit. In the modification example of the first embodiment, differences from the first embodiment will be mainly described.

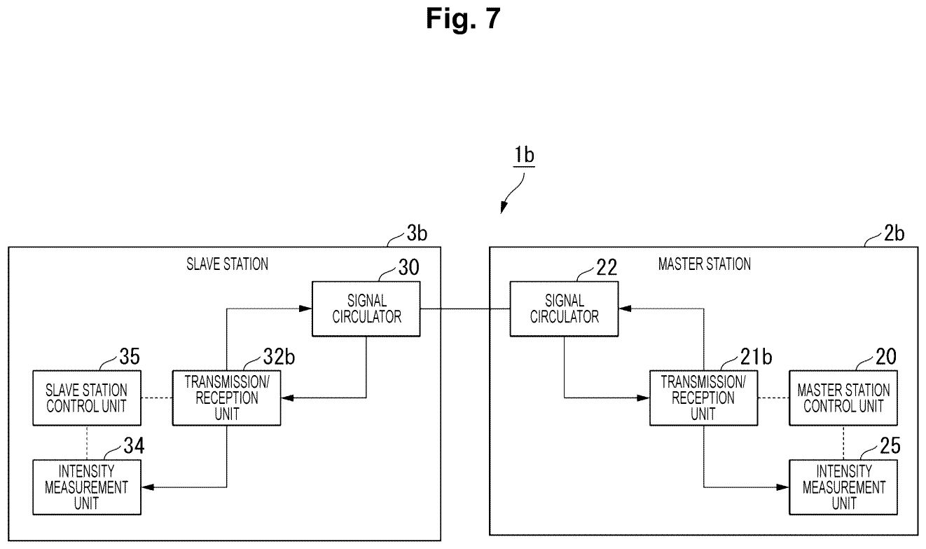

FIG. 7 is a diagram illustrating a configuration example of a communication system 1b in the modification example of the first embodiment. The communication system 1b includes a master station 2b and a slave station 3b. The master station 2b includes a master station control unit 20, a transmission/reception unit 21b, a signal circulator 22, and an intensity measurement unit 25. The transmission/reception unit 21b is integrated with a control signal acquisition unit of the master station 2b. The slave station 3a includes a signal circulator 30, a transmission/reception unit 32b, an intensity measurement unit 34, and a slave station control unit 35. The transmission/reception unit 32b is integrated with a control signal acquisition unit of the slave station 3a. The transmission/reception unit 32b includes, for example, a low pass filter. The transmission/reception unit 32b acquires (extracts) a control signal from an optical signal by using the low pass filter. The transmission/reception unit 32b acquires (extracts) a main signal from the optical signal without using the low pass filter.

Since the transmission/reception unit 21b acquires (extracts) the main signal and the control signal from the optical signal, the master station 2b does not include a variable branching device. Therefore, the master station control unit 20 may not control a branching ratio of the optical signal uplink-transmitted at the variable branching device. In the modification example of the first embodiment, the branching ratio is “1.0”. All the optical power of the optical signal uplink-received by the signal circulator 22 is input to the transmission/reception unit 21b. The master station control unit 20 acquires a result of measuring the optical power of the control signal at the transmission/reception unit 21b from the intensity measurement unit 25.

The master station control unit 20 selects, for the uplink-transmitted optical signal, a combination of a branching ratio and a superimposition ratio that minimizes a sum of main signal loss due to superimposition and branching by using a data table for the branching ratio of “1.0” on the basis of the optical power of the optical signal or the control signal at the transmission/reception unit 21b. The master station control unit 20 notifies the slave station control unit 35 of a request signal for the superimposition ratio of the control signal in the optical signal to be uplink-transmitted, on the basis of the selected combination. Also, the master station control unit 20 acquires the main signal and the control signal uplink-transmitted from the slave station 3b from the transmission/reception unit 21b in an operating stage (a stage after initial setting is done) of the master station 2b.

The transmission/reception unit 21b (TRₓ) acquires the optical signal uplink-received by the signal circulator 22 from the signal circulator 22. The transmission/reception unit 21b converts the acquired optical signal into an electrical signal. The transmission/reception unit 21b outputs the main signal and the control signal (electrical signal) to the master station control unit 20.

The signal circulator 22 outputs the optical signal uplink-transmitted from the slave station 3b to the transmission/reception unit 21b. The signal circulator 22 downlink-transmits the optical signal downlink-transmitted from the transmission/reception unit 21b to the slave station 3b. The intensity measurement unit 25 measures optical power of the control signal at the transmission/reception unit 21b. The intensity measurement unit 25 outputs a result of measuring the optical power of the control signal to the master station control unit 20.

The signal circulator 30 outputs the optical signal downlink-transmitted from the master station 2b to the transmission/reception unit 32b. The signal circulator 30 downlink-transmits the optical signal uplink-transmitted from the transmission/reception unit 32b to the master station 2a.

The transmission/reception unit 32b (TRₓ) acquires the optical signal downlink-received by the signal circulator 30 from the signal circulator 30. The transmission/reception unit 32b converts the acquired optical signal into an electrical signal. The transmission/reception unit 32b outputs the main signal and the control signal (electrical signal) to the slave station control unit 35. The intensity measurement unit 34 measures optical power of the control signal at the transmission/reception unit 32b. The intensity measurement unit 25 outputs a result of measuring the optical power of the control signal to the slave station control unit 35.

Since the transmission/reception unit 32b acquires (extracts) the main signal and the control signal from the optical signal, the slave station 3b does not include a variable branching device. Therefore, the slave station control unit 35 may not control a branching ratio of the optical signal downlink-transmitted at the variable branching device. All the optical power of the optical signal downlink-received by the signal circulator 30 is input to the transmission/reception unit 32b. The slave station control unit 35 acquires a result of measuring the optical power of the control signal at the transmission/reception unit 32b from the intensity measurement unit 34.

The slave station control unit 35 selects, for the downlink-transmitted optical signal, a combination of a branching ratio and a superimposition ratio that minimizes a sum of main signal loss due to superimposition and branching by using a data table for the branching ratio of “1.0” on the basis of the optical power of the optical signal or the control signal at the transmission/reception unit 32b. The slave station control unit 35 notifies the master station control unit 20 of a request signal for the superimposition ratio of the control signal in the optical signal to be downlink-transmitted, on the basis of the selected combination. Also, the slave station control unit 35 acquires the main signal and the control signal downlink-transmitted from the master station 2b from the transmission/reception unit 32b in an operating stage (a stage after initial setting is done) of the slave station 3b.

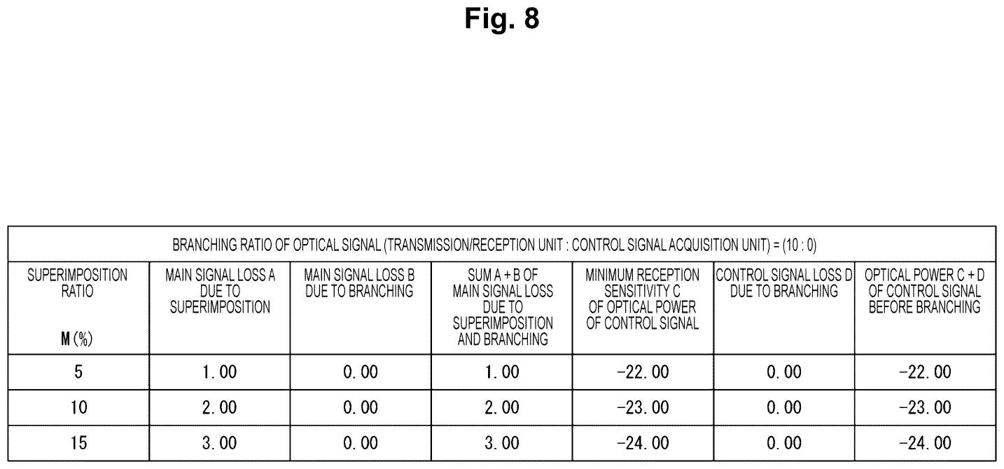

FIG. 8 is a diagram illustrating an example of a data table at “a branching ratio=1.0” in the modification example of the first embodiment. In the data table for each branching ratio, a superimposition ratio, main signal loss due to superimposition (penalty that quality of the main signal takes), a sum of main signal loss due to superimposition and branching, minimum reception sensitivity of the optical power of the control signal, control signal loss due to branching, and optical power of the control signal before branching are associated in advance.

Here, since the transmission/reception unit 32b acquires the main signal and the control signal from the optical signal, and the branching ratio is “1.0”, control signal loss “D” due to the branching is “0.00”. Therefore, minimum reception sensitivity “C” of the optical power of the control signal is equal to the optical power “C+D” of the control signal before branching in the modification example of the first embodiment.

Therefore, the slave station control unit 35 selects a row (range) in which the optical power of the control signal before branching is less than “−13.00” from the data table for the branching ratio of “1.0”. In regard to the data table illustrated as an example in FIG. 8, the slave station control unit 35 selects, as a combination candidate, each of rows in which “optical power of the optical signal received by the transmission/reception unit” is “−22.00”, “−23.00”, and “−24.00”.

The slave station control unit 35 selects, from the candidates, a combination of a branching ratio and a superimposition ratio according to which the optical power of the control signal received by the control signal acquisition unit 33 (the control signal in the second branched signal) is equal to or greater than the minimum reception sensitivity “C” and a sum “A+B” of main signal loss due to superimposition and branching is minimum. The slave station control unit 35 selects, from the candidates, a combination of a branching ratio and a superimposition ratio according to which the condition that the sum of control signal loss “D” due to branching and the minimum reception sensitivity “C” is the optical power “C+D” of the control signal before the branching is satisfied and further, the sum “A+B” of the main signal loss due to superimposition and branching is minimum.

In the data table illustrated as an example in FIG. 8, for example, the slave station control unit 35 selects a combination of a superimposition ratio of “5%” and a branching ratio of “1.0” such that a sum of main signal loss due to superimposition and branching becomes the minimum value “1.00”. In other words, the slave station control unit 35 selects the superimposition ratio “M=5%” in the data table for the branching ratio of “1.0”.

As described above, the transmission/reception unit 21a may acquire not only the main signal but also the control signal from the optical signal. Also, the transmission/reception unit 32a may acquire not only the main signal but also the control signal from the optical signal. In this manner, the communication device is reduced in size, and it is possible to maximize the amount of light that can be used for the main signal with the control signal superimposed thereon while enabling reception of the control signal. Also, it is possible to improve the transmission distance of the optical signal.

### Second Embodiment

A second embodiment is different from the first embodiment mainly in that only a master station includes a control signal acquisition unit and a data table. In the second embodiment, the differences from the first embodiment will be mainly described.

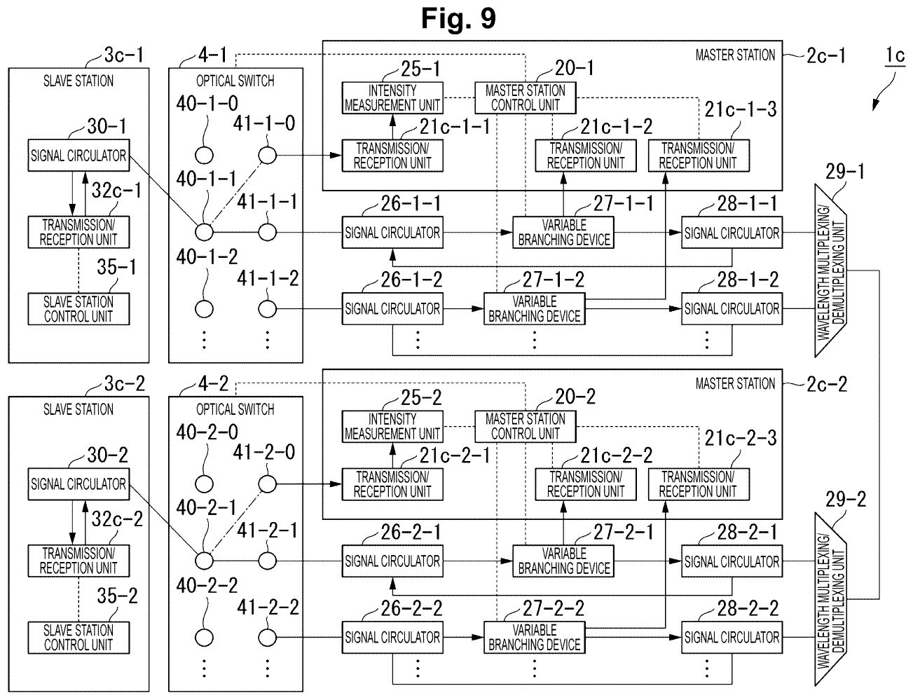

FIG. 9 is a diagram illustrating a configuration example of a communication system 1c in the second embodiment. The communication system 1c includes master stations 2c and a plurality of slave stations 3c. The communication system 1c includes, in a path of an optical signal between a slave station 3c-1 and a slave station 3c-2, a plurality of master stations 2c, a plurality of optical switches 4, signal circulators 26, variable branching devices 27, signal circulators 28, and wavelength multiplexing/demultiplexing units 29.

The slave station 3c-1 faces the slave station 3c-2. An optical switch 4-1 faces an optical switch 4-2. A signal circulator 26-1 faces a signal circulator 26-2. A variable branching device 27-1 faces a variable branching device 27-2. A signal circulator 28-1 faces a signal circulator 28-2. A wavelength multiplexing/demultiplexing unit 29-1 faces a wavelength multiplexing/demultiplexing unit 29-2.

Each master station 2c includes a master station control unit 20, a plurality of transmission/reception unit 21c, and an intensity measurement unit 25. The transmission/reception unit 21c includes a control signal acquisition unit. Each slave station 3c includes a signal circulator 30, a transmission/reception unit 32c, and a slave station control unit 35. Each optical switch 4 includes a plurality of slave station-side ports 40 and a plurality of master station-side ports 41.

A method of selecting a combination of a superimposition ratio and a branching ratio will be described.

The transmission/reception unit 32c superimposes a control signal on a main signal of an optical signal to be transmitted in accordance with control performed by the slave station control unit 35. The transmission/reception unit 32c outputs an optical signal in accordance with the main signal with the control signal superimposed thereon to the signal circulator 30. The signal circulator 30 transmits the optical signal transmitted from the transmission/reception unit 32c to the optical switch 4.

The optical switch 4 switches a path for the optical signal in accordance with control performed by the master station control unit 20. The optical switch 4-1 transmits an optical signal transmitted from the slave station 3c-1 to the transmission/reception unit 21c-1 of the master station 2c-1 in a stage of initial setting before operating of the slave station 3c-1 is started, for example. The optical signal transmitted from the slave station 3c-1 includes a control signal. Note that the optical switch 4-1 transmits the optical signal transmitted from the slave station 3c-1 to the signal circulator 26-1 in an operating stage (a stage after initial setting is done) of the slave station 3b.

The signal circulator 26 transmits the optical signal transmitted from the optical switch 4 to the variable branching device 27. The signal circulator 26 transmits the optical signal transmitted from the signal circulator 28 to the optical switch 4. The variable branching device 27 branches the optical signal transmitted from the signal circulator 26 into the master station 2c and the signal circulator 28 in accordance with control performed by the master station control unit 20. The signal circulator 28 transmits the optical signal transmitted from the variable branching device 27 to the wavelength multiplexing/demultiplexing unit 29. The signal circulator 28 transmits the optical signal transmitted from the wavelength multiplexing/demultiplexing unit 29 to the signal circulator 26.

The wavelength multiplexing/demultiplexing unit 29 multiplexes optical signals with a plurality of wavelengths. For example, the wavelength multiplexing/demultiplexing unit 29-1 multiplexes optical signals with a plurality of wavelengths transmitted from the plurality of signal circulators 28-1. The wavelength multiplexing/demultiplexing unit 29-1 transmits the multiplexed optical signal to the wavelength multiplexing/demultiplexing unit 29-2.

The wavelength multiplexing/demultiplexing unit 29 demultiplexes the multiplexed optical signal into optical signals with a plurality of wavelengths. For example, the wavelength multiplexing/demultiplexing unit 29-1 demultiplexes the multiplexed optical signal transmitted from the wavelength multiplexing/demultiplexing unit 29-2 into optical signals with a plurality of wavelengths. The wavelength multiplexing/demultiplexing unit 29-1 transmits the demultiplexed optical signals to the plurality of signal circulators 28-1.

The master station control unit 20 controls operations of each functional unit of the master station 2c. In a case where the slave station 3c-1 transmits a control signal in a stage of initial setting before operating of the slave station 3c-1 is started, for example, the master station control unit 20-1 connects the master station-side port 41-1 of the optical switch 4-1 to the transmission/reception unit 21c-1. In this manner, the optical signal transmitted from the slave station 3c-1 is input to the transmission/reception unit 21c-1 via the optical switch 4. Here, the master station control unit 20-1 acquires a result of measuring optical power of the control signal at the transmission/reception unit 21c-1 from the intensity measurement unit 25-1.

Although the selection method in the first embodiment or the modification example of the first embodiment and the selection method in the second embodiment are similar, loss caused by each optical component in the path of the optical signal is taken into consideration in advance in each data table in the second embodiment. The optical component is, for example, the optical switch 4.

The master station control unit 20 notifies the slave station control unit 35 of a superimposition ratio in a selected combination. The master station control unit 20 notifies the optical switch 4 of the path of the optical signal. The master station control unit 20 sets a branching ratio in the selected combination for the variable branching device 27. The slave station 3c-1 communicates with the facing slave station 3c-2 by using an optical signal in accordance with the main signal with the control signal superimposed thereon.

Note that the fact that the control signal can be transmitted in both directions as described above is a matter that is common to each embodiment and modification examples thereof. Since the control signal can be transmitted in both directions, the master station 2c may be described as a first communication device” or a “different communication device”, while the slave station 3c may be described as a “second communication device” or a “host communication device”. The master station 2c may be described as a “second communication device” or a “host communication device”, while the slave station 3c may be described as a “first communication device” or a “different communication device”.

As described above, only the master station 2c may include the control signal acquisition unit (transmission/reception unit 21c) and the data table. In this manner, it is possible to maximize the amount of light that can be used for the main signal with the control signal superimposed thereon while enabling reception of the control signal. Also, it is possible to improve the transmission distance of the optical signal.

### Modification Example of Second Embodiment

One of differences of a modification example of the second embodiment from the second embodiment is that only a slave station includes a data table and only a master station includes a control signal acquisition unit. In the modification example of the second embodiment, the differences from the second embodiment will be mainly described.

A slave station control unit 35 executes communication with a master station control unit 20 in a stage of initial setting before operating of a slave station 3a is started. For example, the slave station control unit 35 and the master station control unit 20 communicate optical power of a received optical signal and information regarding a superimposition ratio. The slave station control unit 35 derives a combination of a branching ratio and a superimposition ratio that minimizes a sum of main signal loss due to superimposition and branching on the basis of a data table for each branching ratio. The slave station control unit 35 notifies the master station control unit 20 of a request signal for the branching ratio in the derived combination. The master station control unit 20 controls operations of the variable branching device 27 in a path of an optical signal of the slave station 3a such that the variable branching device 27 branches the optical signal at a requested branching ratio.

As described above, only the master station 2c may include the control signal acquisition unit (transmission/reception unit 21c). Only the slave station 3c may include the data table. The master station 2c and the slave station 3c may communicate the optical power of the received optical signal and the information regarding the superimposition ratio. In this manner, it is possible to maximize the amount of light that can be used for the main signal with the control signal superimposed thereon while enabling reception of the control signal. Also, it is possible to improve the transmission distance of the optical signal.

### Hardware Configuration Example

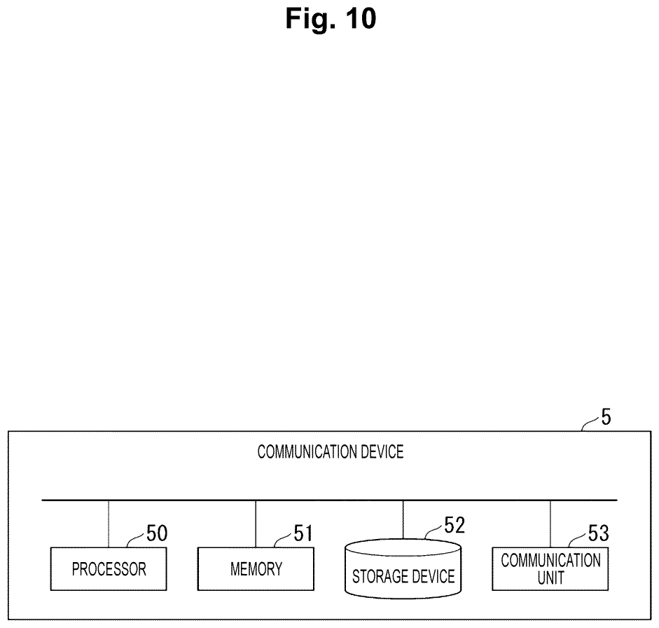

FIG. 10 is a diagram illustrating a hardware configuration example of the communication device in each embodiment. A communication device 5 corresponds to at least one of the master station and the slave station in each embodiment. The communication device 5 includes a processor 50. The present invention is implemented as software by the processor 50 such as a central processing unit (CPU) executing a program stored in a storage device 52 including a non-volatile recording medium (non-transitory recording medium) and a memory 51. The program may be recorded in a computer-readable non-transitory recording medium. The program may be a multi-thread program. The computer-readable non-transitory recording medium is a non-transitory recording medium, for example, a portable medium such as a flexible disk, a magneto-optical disk, a read only memory (ROM), or a compact disc read only memory (CD-ROM), or a storage device such as a hard disk built in a computer system. A communication unit 53 executes predetermined communication processing.

At least some of functional units in the communication device 5 may be analog circuits or digital circuits. A signal processing device may be implemented by using hardware including an electronic circuit or circuitry using, for example, a large scale integrated circuit (LSI), an application specific integrated circuit (ASIC), a programmable logic device (PLD), or a field programmable gate array (FPGA).

Although the embodiments of the present invention have been described in detail with reference to the drawings, the specific configurations are not limited to the embodiments and include design and the like within the scope not departing from the gist of the present invention.

### INDUSTRIAL APPLICABILITY

The present invention can be applied to optical communication systems.

### REFERENCE SIGNS LIST

1a, 1b, 1c Communication system
2a, 2b, 2c Master station
3a, 3b, 3c Slave station
4 Optical switch
5 Communication device
20 Master station control unit
21a, 21b Transmission/reception unit
22 Signal circulator
23 Variable branching device
24 Control signal acquisition unit
25 Intensity measurement unit
26 Signal circulator
27 Variable branching device
28 Signal circulator
29 Wavelength multiplexing/demultiplexing unit
30 Signal circulator
31 Variable branching device
32a, 32b Transmission/reception unit
33 Control signal acquisition unit
34 Intensity measurement unit
35 Slave station control unit
40 Slave station-side port
41 Master station-side port
50 Processor
51 Memory
52 Storage device
53 Communication unit
100 Main signal
101 Control signal
310 Base
311 Optical fiber

1. A communication device comprising:
a variable branching device that acquires, from a different communication device, an optical signal in accordance with a main signal with a control signal superimposed thereon at a superimposition ratio provided through a notification and branches the main signal into a first branched signal and a second branched signal in accordance with a designated branching ratio;
a processor; and
a storage medium having computer program instructions stored thereon, when executed by the processor, perform to:
measures optical power of the control signal in the second branched signal; and
selects a combination of the superimposition ratio and the branching ratio that minimizes a sum of main signal loss due to superimposition and branching from among combination candidates on the basis of minimum reception sensitivity of the optical power of the control signal and a result of measuring the optical power of the control signal, notifies the different communication device of the superimposition ratio in the selected combination, and designates the branching ratio in the selected combination for the variable branching device.

2. The communication device according to claim 1, wherein the computer program instructions further perform to selects a combination according to which the optical power of the control signal in the second branched signal is equal to or greater than the minimum reception sensitivity and the sum of the main signal loss is minimized.

3. A communication system comprising: a first communication device; and a second communication device,
wherein the first communication device includes
a transmission unit that superimposes a control signal on a main signal at a superimposition ratio provided through a notification and transmits an optical signal in accordance with the main signal with the control signal superimposed thereon, and
the second communication device includes
a variable branching device that acquires the optical signal from the transmission unit and branches the main signal into a first branched signal and a second branched signal in accordance with a designated branching ratio,
a processor; and
a storage medium having computer program instructions stored thereon, when executed by the processor, perform to:
measures optical power of the control signal in the second branched signal, and
selects a combination of the superimposition ratio and the branching ratio that minimizes a sum of main signal loss due to superimposition and branching from among combination candidates on the basis of minimum reception sensitivity of the optical power of the control signal and a result of measuring the optical power of the control signal, notifies the first communication device of the superimposition ratio in the selected combination, and designates the branching ratio in the selected combination for the variable branching device.

4. A communication method that is executed by a communication device, the method comprising the steps of:
acquiring, from a different communication device, an optical signal in accordance with a main signal with a control signal superimposed thereon at a superimposition ratio provided through a notification and branching the main signal into a first branched signal and a second branched signal in accordance with a designated branching ratio;
measuring optical power of the control signal in the second branched signal; and
selecting a combination of the superimposition ratio and the branching ratio that minimizes a sum of main signal loss due to superimposition and branching from among combination candidates on the basis of minimum reception sensitivity of the optical power of the control signal and a result of measuring the optical power of the control signal, notifying the different communication device of the superimposition ratio in the selected combination, and designating the branching ratio in the selected combination for a variable branching device that branches the main signal into a first branched signal and a second branched signal.
